(19) United States
(12) Patent Application Publication
(10) Pub. No.: US 2017/0241590 A1
(43) Pub. Date: Aug. 24, 2017

(54) A SUPPORT FOR A DEVICE INCLUDING A DISPLAY

(71) Applicant: Toggle Designs Limited, Hove (GB)

(72) Inventor: Clair Stringer BOUBLI, Hove (GB)

(21) Appl. No.: 15/521,767

(22) PCT Filed: Nov. 4, 2015
(86) PCT No.: PCT/IB2015/058515

§ 371 Date: Apr. 25, 2017

(30) Foreign Application Priority Data
Nov. 4, 2014 (GB) 1419644.8

(51) Int. Cl. F16M 13/06; H02J 7/00; F16M 11/22; G06F 1/16; F16M 13/04; F16M 11/04

(52) U.S. Cl. CPC F16M 13/06; F16M 13/04; F16M 11/041; F16M 11/22; G06F 1/1632; H02J 7/0044; F16M 2200/08

(57) ABSTRACT

The present invention relates to a support for supporting and charging an electrical device such as a tablet, e-reader or similar device. The support 1 has a body 2 having opposed first and second faces 3, 4, the first face 4 of the body 2 configured to provide a stable base suitable for resting on a surface, a slot 5 formed in the second face 3, the slot 5 is adapted to receive and grip one edge of a tablet device. The body 2 is adapted to snugly fit the palm of a user's hand and includes a plurality of indents 6 for receiving a user's fingers. The slot 5 and first face 4 configured so that when the first face 4 is located on a surface the support 1 will provide a stable multidirectional support for a tablet located in the slot 5 and extending outwards from the body 2. The support permits devices to be more easily held for long periods of time.

### FIELD OF THE INVENTION

The present invention relates to a support for supporting an electrical device such as a tablet e-reader or similar device either when held in the hand of a user, or freestanding on a surface.

### BACKGROUND

Tablets, e-readers and similar devices are becoming increasingly common and widely-used. These devices are usually manufactured to be as flat and as thin as possible, and the decreased thickness of newer versions is often used as a selling point. While the flat profile of these devices makes them easy to store and transport and easy to use for short periods, the profile of these devices can make them uncomfortable for some users to grip or grasp and use over longer periods, the force required to grip the tablet or reader contributing to the hand and grip fatigue of a user. Tablets may be used on surfaces for example in use with an attached keyboard or being used as a keyboard or for viewing long video formats or freely for example when used for reading or surfing. With automatic software orientation, tablets may be required to be oriented landscape or portrait for periods of time.

### PRIOR ART

Accordingly a number of patent applications have been filed in an attempt to resolve the problem or similar, including the following:

US Patent Application US20130277998 (Ghaznavi) describes and shows a single-hand holding device for the user to grab and hold a tablet computer. The holding device can be used in a horizontal or vertical position. The holding device can serve as a stand to set on a desk or other flat surface. The holding device has a base with a u-shaped channel to hold multiple-sized tablet computers. The base of the holding device includes four finger openings to secure fingers while hand secures the holding device.

US Patent Application US20120327593 (Finnegan et al) describes and shows a tablet computer holding device comprising a pair of grip portions engaging the tablet computer and a bridge portion connected to and in communication with the grip portions. The ergonomically shaped grip portions include an engagement notch, thumb groove, and plurality of finger grooves to provide a comfortable handle for holding a tablet computer. The bridge portion includes an anti skid surface and is elastic and extensible to allow the device to be attached to various sizes of tablet computers and to be used with either the portrait or landscape orientation of the tablet computer.

US Patent Application US20120267402 (Beatty) describes and shows an accessory that attaches to an electronic multimedia device such as an E-Reader, where the user slips a hand under an elastic material that forms part of the accessory to receive support while holding the device. This accessory allows a more comfortable and secure multimedia experience even allowing navigation with the same hand that holds the device. An optional attachment fits around this accessory without obstructing its hand-support functionality while retracted, and opens at variable angles to support the device on a working surface for hands-free viewing at continuously selectable angles.

Chinese Utility Model CN202452046U (Cooler Master Co Ltd) discloses a support seat for a portable-type electronic device.

### SUMMARY OF THE INVENTION

According to the present invention there is provided a support for a device including a display comprising: a body having a first face defining a base for resting on a surface, a second face having an elongate slot formed in the body for receiving the device, so that when the first face is located on a surface the device supported in the slot extends outwards from the body; the support is flexible so as to enable the body to be flexed by a user so as to open the slot to a wider state to receive the device and then released to a released state wherein the slot engages with the device; and a plurality of indents are formed on the body which are shaped to receive a user's fingers.

This configuration allows a ser to comfortably hold a device such as tablet or similar device in their hand by means of the support (s) without having to exert uncomfortable gripping force, and also allows a user to rest the tablet upright on a surface for reading or similar.

It is appreciated that more than one support may be arranged on a device in use. For example one support may be arranged each side of a display so that a user engages both hands when holding the display by means of the two supports.

Advantageously the device is adapted to be easily gripped by the user so that it less likely to be dropped.

In preferred embodiments the base is substantially flat so as to provide a stable base for the support when located on a surface. Therefore the support may have a substantially hemispherical profile.

In some embodiments the body is substantially ellipsoid enabling the support to be comfortably held in the hand of a user. The body may be shaped so as to fit comfortably in the user's hand.

Typically the slot extends substantially across the wide axis of the body so as to provide maximal engagement of the device in the slot. This arrangement also helps to provide a configuration where a user can comfortably hold the support in their hand with the display aligned towards them.

The slot preferably substantially bisects the body. This allows a wide tablet to be used with a smaller support, the tablet overlapping the ends or edges of the support whilst still remaining securely supported.

In preferred embodiments at least one side of the body comprises a plurality of indents configured to receive the fingers of a user's hand. This assists with providing comfortable and secure grip to a user.

Typically the lower face of the body rests in the palm of a user's hand and the user's fingers wrap around the support wherein each fingers sits within an indent for enhanced grip.

In some embodiments the ends of the innermost indents are configured to provide a stable base for the support when resting on the indented side in use. Typically the ends are flattened and dimensioned such that at least two ends of the indents can engage with the surface. This allows a device to be used with one end or edge of the device in the slot and the opposed edge resting on a surface, so that the device is angled upwards slightly. In this way the device held in the support is arranged at a shallow angle for viewing. This arrangement of the indents having flattened ends also helps to prevent the device from rocking from side to side when viewed.

Typically the upper face of the body is rounded. This helps the body to fit more naturally within the hand of a user with their fingers curled around the body,

In a preferred embodiment at least the inner surface of the slot comprises a non-slip material. This helps to prevent a device in the slot from slipping out or moving out of position during use. Advantageously this reduces risk of damage to the device by: preventing the device from falling from the support and by preventing movement of the device in the slot that may cause rub marks to develop on the device.

The non-slip material may be silicone natural or synthetic rubber or similar material. This is an inexpensive, and easily sourced material that has excellent non-slip properties.

In some embodiments the non-slip material is textured to assist in providing non-slip properties.

In some further embodiments the non-slip material may be shiny and reliant on localised deformation to provide adhesive or non-slip properties, for example the non-slip material may be resiliently deformable such as having a flexible elastomeric coating.

In some embodiments the support may include a flexible outer layer or cover, for example a transparent protective layer.

The slot can be flexed to a wider state than the natural rest state by applying force to the body, typically deforming the body so that the slot is manipulated. This helps a user to emplace one edge of a device in the slot. Advantageously this removes the requirement for the device to be wedged into a tight gap that may be difficult for some users such as children or the frail and elderly.

Furthermore by flexing the support to provide a wider slot the device can be inserted without risk of being scratched or worn over repeated uses.

Typically the device is made from a flexible resiliently deformable material that permits the device to be flexed when force is applied in such a way that the slot is opened to a wider state for receiving the device. When the applied force removed the slot closes to the original, released state wherein at least part of the slot is in contact with the device.

For example the support may be made from flexible synthetic plastic, rubber or a cellular material such as dense foam.

In this way the body is deformed in order to cause wider opening of the slot, thereby providing a gripping mechanism to receive and hold the device.

Preferably the body is formed from a resiliently deformable material that allows the body to be deformed under application of force whilst returning to a released state when the force is removed. For example the support is ‘pinched’ by a user to widen the slot. Therefore the spring means are integrated within the body, typically enabled by configuration of the body and slot in conjunction with the material from which the body is formed.

In some embodiments the body may include an internal spring means that aids to open the slot. The spring means are configured to apply pressure to the sides of the slot. This assists with closing the slot onto the edges of the device after the body has been deformed and the slot widened. Therefore the spring means is typically gripping the device when at rest.

The spring means may comprise a leaf spring embedded within the body. This provides a simple and effective spring mechanism.

In some other embodiments the slot includes members that move or deform as the device is inserted into the slot so as to securely receive the device, providing an alternative or additional gripping mechanism.

The member(s) may be inserted or integral to the slot, typically having a portion that extends into the body, and a portion that projects from the slot. The member(s) may act to bridge the slot at rest, and can be displaced by entrance of the device in use, wherein the members remain in contact with the device when displaced to aid in gripping the device. For example the members may be attached to the body by hinges and may be sprung biased to cover the slot until a force is applied to displace the members. In other embodiments the members may be flexible projections that deform when in contact with the device.

In some embodiments a plurality of such members are included, for example spaced along the slot or distally located at ends thereof. In this way the device is not liable to undesirable twisting, even when in the slot in a landscape orientation.

Typically the slot comprises a first substantially planar side and a concave second side. This helps the slot to configure to the shape of the device, which normally have a flat front and edges that curve upwards to meet the flat front.

Preferably the slot is adapted to correspond to the device that it will be held. For example the slot profile may relate to profiles of the devices. It is envisaged that different supports may be provided to accommodate devices.

The slot may also be configured to relate to features of the device's edge(s) and such as including recessed portions to permit access to any ports or buttons on the device.

In some further embodiments the slot may comprise or include a displaceable aftermarket adaptor that can be fitted to the support wherein each adaptor is dimensioned according to each device. In this way the slot is a self-contained unit for insertion into or onto the body as appropriate. A plurality of different slots may be used in any one support so as to adapt the support for maximum usage. For example the adaptors may be interchangeable so as to modify the slot for the device to be received.

In some embodiments the slot is formed from a resiliently deformable material so as to be able to mould to different devices therefore requiring the slot to be dimensioned to one particular device.

In some embodiments the slot may have a tear drop sectional profile that can be widened at the opening to accept the device and then allowed to close about the device so as to grip the device. In this way only part of the slot may be in contact with the device and the slot can readily accommodate device of different dimensions.

In some embodiments the body is moulded in two parts an upper and lower, wherein the upper includes a widening/expanding slot. This can enable the support to be made in parts and then assembled which can be advantageous for some manufacturing techniques, particularly those using moulds.

In some embodiments the main body comprises a semi-rigid polymer over-moulded with a soft rubber or similar material. The semi-rigid polymer assists the body to shape, while the material assists a user with grip and helps to soften the so that this is more comfortable for a user.

The body may comprise a thermoplastic elastomers (TPE) overmoulding. In some embodiments only the slot includes a silicone, over moulding and only to interior surfaces, so as to assist in gripping and avoidance of damage to the device.

Typically the body is at least partly hollow. This aids with manufacture and keeping the support lightweight. For example the weight and volume of materials used can be reduced. This can also make it easier for the body to be flexed and provides internal storage for other components.

In some embodiments extra weight may be situated in or on the body for greater stability when the support is located on a surface. The weight or weights are typically adding during in manufacture. Accordingly such weight is ideally located distal to the device in or on the body, or configured to otherwise to balance the pivot weight of an outwardly extending device.

For example an elongate weight may be arranged each side and parallel to the slot. Ideally the weights are integrated with the support. Typically the weights are within the body so as not to be visible in use.

In another preferred embodiment the support includes a charging means so as to permit charging of the device, which is held on or in the support during use. In this way the device can be charged when located in or on the support. Advantageously the user does not need to remove the support so as to charge the device so use is uninterrupted.

Typically the support includes a charging port that engages with the device so as to permit charging. Ideally the charging means includes a transformer for providing a charging current.

Preferably the charging means may include a docking station that is adapted to correspond to the device, so as to couple with charging ports of the device. Typically the dock may be arranged in the slot. Advantageously this may aid with holding the device in the slot.

In some embodiments the docking station may be retractable so that it can be extended for use when needed and then retracted when not required.

In some embodiments the support includes at least one electrical port to enable connection to the device, another device and/or a power source. In this way a power supply can be provided to the charging means and/or a cable from the device can be connected to the port in order to enable charging.

Typically the port may be arranged below an end of the elongate slot so as not to interfere with the device and so as not be in a region where the user's hand is located in use.

Typically the port may include but is not limited to a universal serial bus (USB) or other computer bus, lightning connector such as an Apple Lightning Connector®.

Typically the charging means and any port may be integrated with the support, for example being housed within the body.

In some embodiments the support may include an internal chamber within the body for storing component parts such as cables, connectors or spare batteries.

Preferably the charging means may includes at least one energy storage means or ‘power bank’ such as at least one, cell or battery to provide an internal power supply within the support to power and/or charge the device.

Ideally the at least one battery may be chargeable so as to permit the at least one battery to be charge by an external power supply.

In this way the power bank within the support can be charged and energy stored in the device by means of the cell(s) or battery/batteries (the power bank) so that the support can provide power to any items subsequently connected to it.

For example, the power bank within the support may be charged by connecting the support to a mains power supply. Once charged the energy is stored in the power bank until a device is connected to the support so as to draw energy from the power bank.

Alternatively the support may utilise non-rechargeable batteries and spent batteries may be removed and replaced.

In some embodiments the charging means are adapted to enable inductive charging so as to permit wireless charging of a device. For example the support may include a charging station that generates an electromagnetic field and enables transfer of energy between two or more objects (the support and one or more device) by way of an inductive coupler.

The device is arranged on, or in close proximity to, the inductive charging means so as to ensure that inductive charging can occur effectively. For example the device may be arranged at a particular orientation on the support for optimal charging.

In some other embodiments the support may include a memory means so as to permit storage of data on the support. For example the support may be capable of storing music or videos.

In some embodiments the support may include fingerprint recognition technology so that charging means or data stored on the memory means can only be accessed by designated users.

Preferred embodiments of the invention will now be described by way of example and with reference to the Figures in which:

### BRIEF DESCRIPTION OF FIGURES

FIG. 1 shows asp overview preferred embodiment of a support;

FIG. 2 shows top view of the embodiment shown in FIG. 1;

FIG. 3 shows a bottom view of the embodiment shown in FIG. 1;

FIG. 4 shows a side view of the embodiment shown in FIG. 1;

FIG. 5 shows a side view of the embodiment shown in FIG. 1;

FIG. 6 shows a side view the embodiment shown in FIG. 1;

FIG. 7 shows an exploded view of the embodiment shown in FIG. 1;

FIG. 8 shows are overview of second embodiment of a support;

FIG. 9 shows a side view of the support of FIG. 8, showing the rounded upper face of the main body, and showing the slot formed having a one substantially planar side and a second concave side.

FIG. 10 shows a cutaway view of the support shown FIG. 8; and

FIG. 11 shows an exploded view of the support shown in FIG. 8.

### DETAILED DESCRIPTION OF FIGURES

A preferred embodiment of support now be described with reference to the figures.

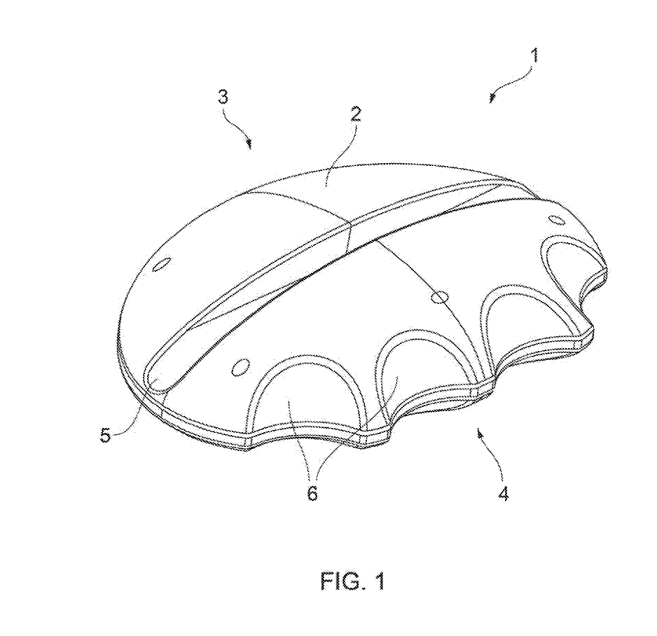

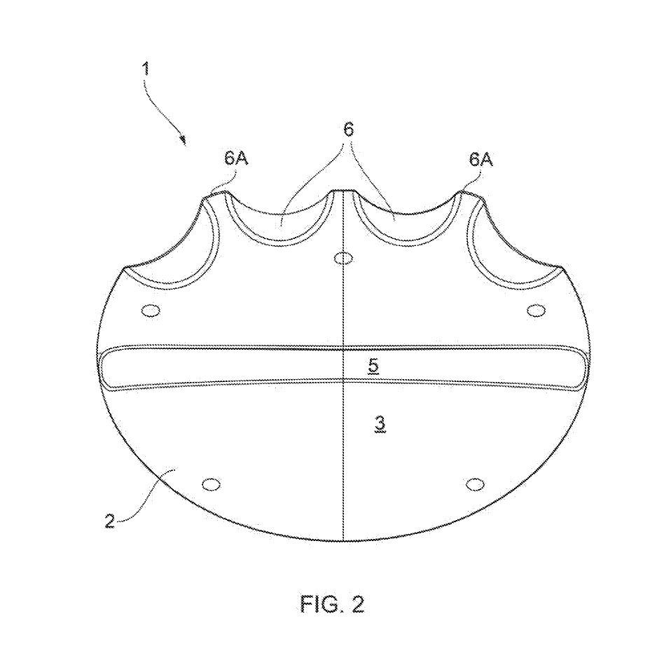

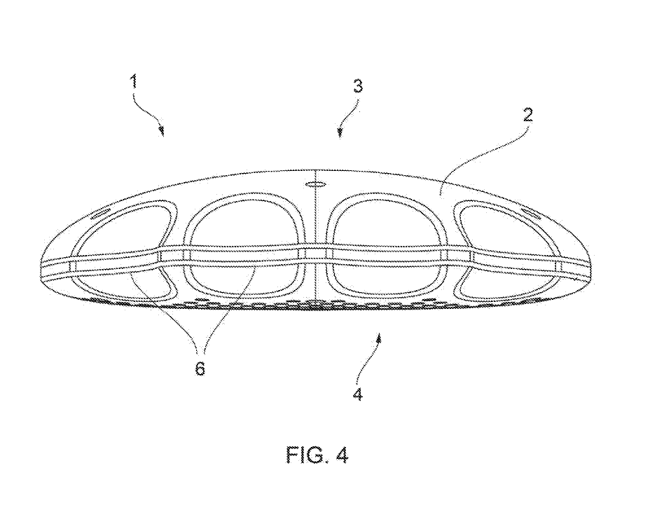

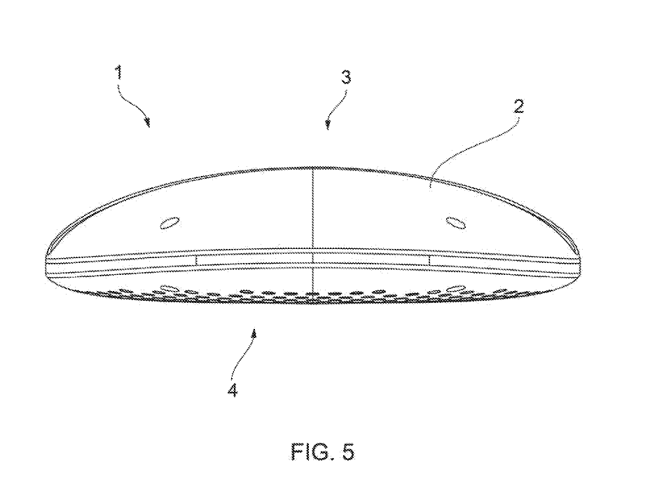

FIGS. 1 to 7 show a first embodiment of the support 1. The support 1 has a substantially ellipsoid body 2, having an oval footprint. The body 2 has an elongate slot 5 that extends across its long axis.

The slot for receiving a device such as a tablet or similar electronic device with a display.

The body 2 has an upper face 3 that includes the slot 5 for receiving the device (not shown) and a lower face 4 that is located on a surface when the device is not held.

On one edge of the body 2 are a plurality of indentations 6 which are adapted to receive the fingers of a user to enable them to easily grip the support 1. The first embodiment has 4 indents 6, one for each finger.

The indents 6 are semi-circular. The ends 6A of the indents 6 are flattened so as to be suitable for resting against a surface when the support is arranged in a second configuration in which the device is supported at a shallow angle relative to the surface on which it is resting. For example so that a keypad on a tablet can be easily used.

The body 2 is flexible so that it may be flexed in order to open the slot 5 to a wider state which enables the device to be readily inserted into the slot 5.

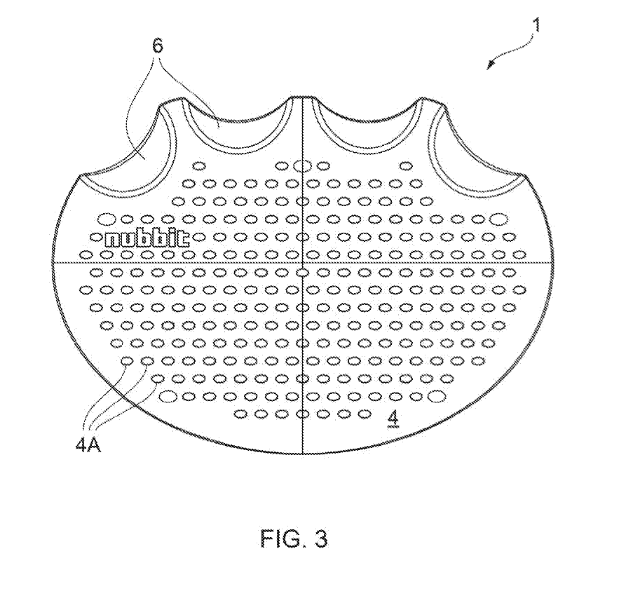

The lower face 4 of the support 1 has a textured surface 4A (see FIG. 3). The textured surface 4A enables helps prevent the support from slipping when position on a surface.

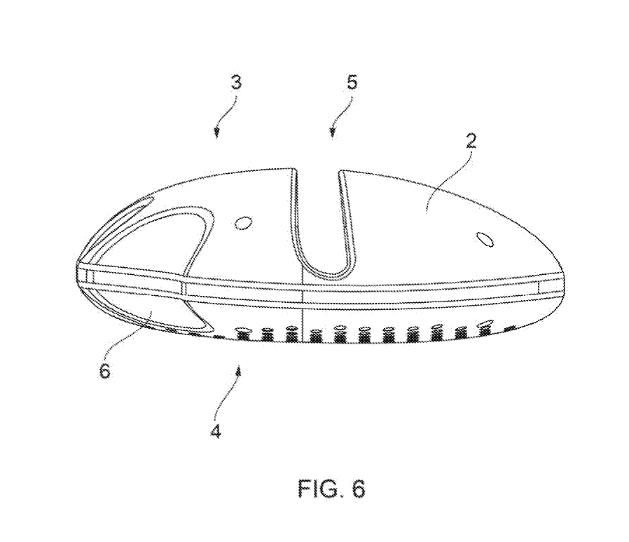

FIG. 6 shows a side view of the first embodiment of the support 1. The slot 5 is dimensioned to receive a tablet (not shown) so as to exactly match the profile of the tablet to ensure the slot is securely engaged with the slot in use.

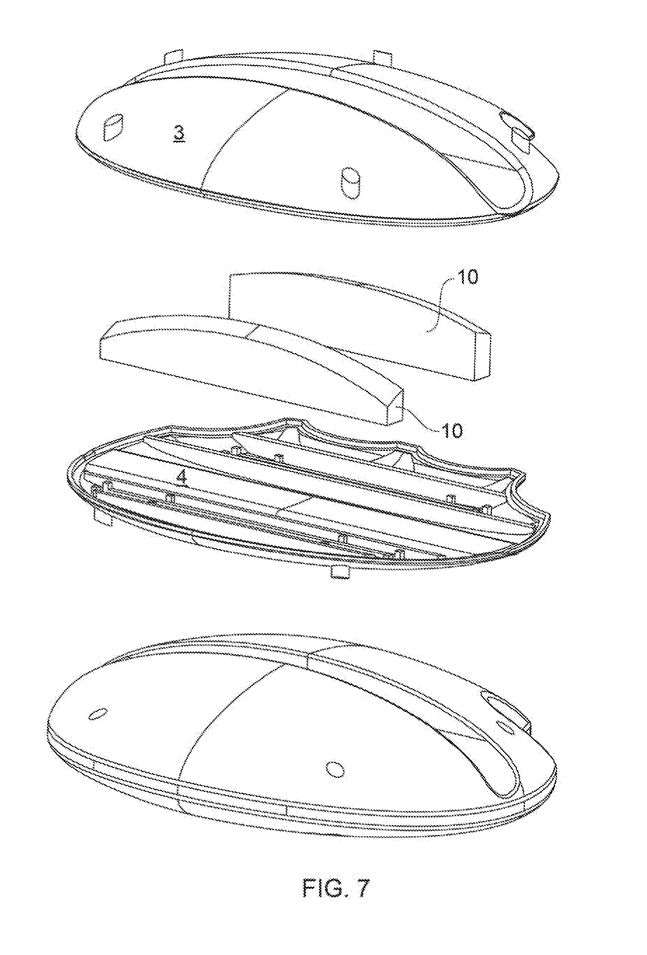

FIG. 7 shows an exploded view of the support 1. The support is formed from two parts, the upper face 3 and the lower face 4. There is a cavity define between the two parts when joined, therefore the support is hollow.

Within the cavity are provided to weights 10. The weights ensure the support is stable when supporting a device.

The weights 10 are arranged either side of the slot so as to not encumber the slot and so as to permit the slot to be flexed open to a wider state without being restricted or prevented by the weight(s).

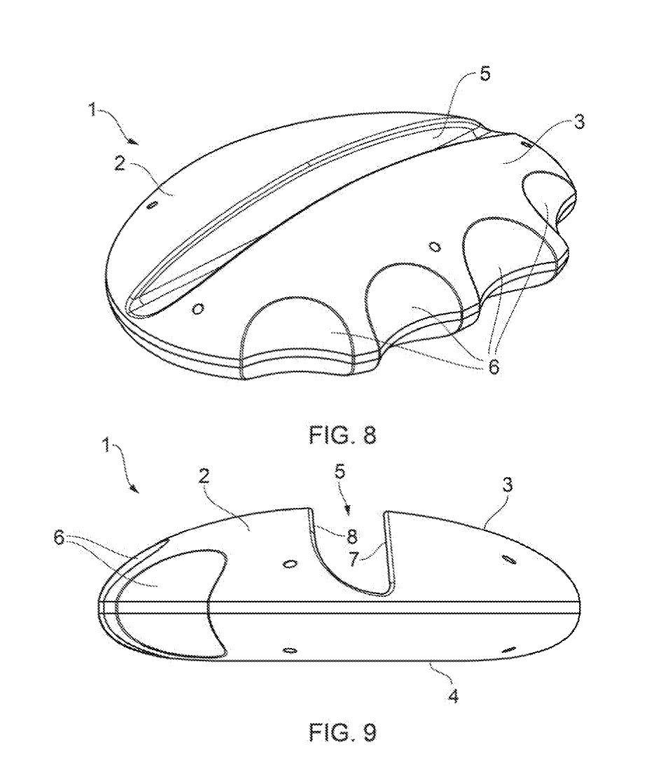

FIG. 8 showing the second embodiment shows a perspective view from one side and above of the second embodiment of the support. The support has a body with opposed upper and lower faces (3, 4), the lower face 4 of the body configured to provide a stable base suitable for resting on a surface, a slot 5 formed in the upper face 3, the slot 5 configured to receive and grip one edge of a device (not shown).

The body is configured to snugly fit the palm of a user's hand, the slot 5 and lower face 4 configured so that when the lower face 4 is located on a surface the support will provide a stable multidirectional support for a device located in the slot 5 and extending outwards from the body 2.

The body has a plurality of finger indents 6 formed on a side of the body that receives the fingers of a user and help them to grip the body in use.

The support 1 has a body 2 that is generally oval in plan view, and which has opposed upper and lower faces 3, 4. The main body 2 is sized to fit snugly with the hand of an average user, so that it will sit comfortably in their palm and they can wrap their fingers around and over the top of the main body 2. The lower face 4 is flat, and is configured to provide a stable base when the main body 2 is resting on a surface.

The upper face 3 is rounded. This helps the body 2 to sit naturally within the palm of a user's hand, with their fingers curled around the body.

A slot 5 is formed in the upper surface, across the longest dimension or longest axis of the body 2, bisecting the body 2. The slot 5 divides the body 2 into a front side and a rear side. The slot 5 is configured to receive and grip one edge of a device in use in a manner that will be described in detail below.

Four finger indents 6 are formed in the rear side of the main body. These are sized and shaped so that the fingers of a user holding the tablet support tool 1 in the palm of their hand will curl around and into the indents 6, which assist a user with gripping the tablet support tool 1.

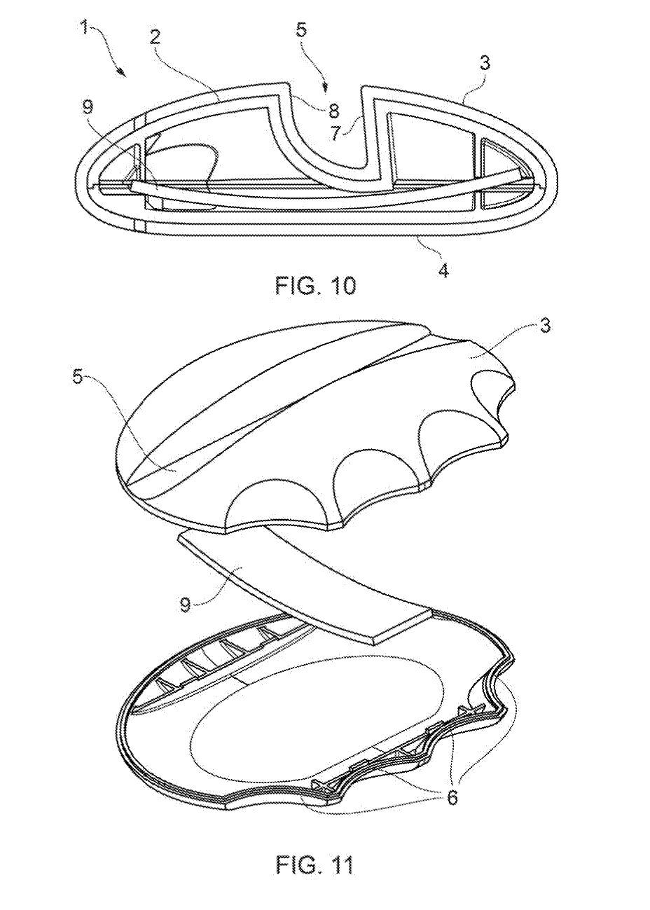

As best, shown in FIGS. 9 and 10, the slot 5 comprises a first substantially planar side 7 and an outwardly curved or concave second side 8. Most tablets or similar devices have a flat front, the edges of the rear curved upwards to meet the flat front. This shape of slot 5 helps the slot 5 to conform and mould against a tablet in position in the slot 5.

The body 2 is formed so as to be hollow. As shown in FIGS. 10 and 11, a leaf spring 9 is located in the body 2. The leaf spring 9 is positioned to apply pressure to the edges of the slot 5 and to move these towards one another, and to provide reaction force to move the edges towards one another if they are moved away from one another. A user can flex the body 2 slightly to widen the slot 5 to position a device in the slot 5, and once in position the leaf spring 9 will help to close the slot 5 around the edge of a tablet in the slot 5.

The body 2 of the support is preferably formed from a semi-rigid polymer that provides a shape for the body 2 and which assists the body 2 to maintain its shape. The semi-rigid polymer is over-moulded with a soft rubber material coating. This assists a user with grip and helps to soften the surface so that this is more comfortable for a user.

The coating covers the inner surface of the slot 5 and helps to provide a non-slip material which assists with preventing a tablet in the slot 5 from slipping out or moving out of position. The slot 5 could also be coated with a non-slip coating separately to the body coating. The non-slip material in this embodiment is silicone rubber type material, which is an inexpensive and easily sourced material that has excellent non-slip properties. The non-slip material in this embodiment is also textured within the slot 5 to assist in providing non-slip properties.

The non-slip material in the slot could also be smooth, for example being shiny.

Other parts of the outer face of the body may be textured in addition to or as an alternative to the slot and lower face.

In use, a user can use the tablet support tool 1 in a number of ways, as outlined below:

Firstly, they can place a device such as an e-reader in the slot 5 and then hold the body 2 in the palm of their hand with their fingers curled into the indents 6 around the rear of the tablet. This assists a user with holding the device comfortably as they do not have to exert a strong pinch grip that can fatigue their fingers and cause discomfort in order to hold the device. They can hold the body from underneath, or to one side.

Secondly, they can use the flat lower surface 4 as a base, placing a tablet in the slot 5 so that it extends upwards from the body and then placing the tablet support tool 1 on a table or similar. The body 2 is sized and shaped, and the slot 5 is positioned, so that the tablet support tool 1 will provide a robust and stable multidirectional support for the tablet (it will not easily overbalance).

Thirdly, the support 1 can be deliberately overbalanced so that one end or edge of the tablet is in the slot 5, and the opposed edge is resting on a surface. The tablet will be angled upwards at a shallow angle. The outer ends between the indents 6 are spaced apart and shaped to provide a stable base for the body when resting on the indented side in use as described. That is, the indents are configured so that the tablet is prevented from rocking from side to side in use.

In alternative forms, the body can be formed from aluminium or a similar solid or shell material, with only the interior of the slot 5 coated. The front and rear of the body each side of the slot could be formed separately and held together by a hinge or similar, the slot closed by a spring similar to that described above.

Where the word ‘tablet’ is used in this specification, this should not be taken as limiting the meaning to electronic devices classified as tablets only—the word as used in this specification should be taken to mean a tablet or any similar electronic device such as an e-reader, or any mobile computing device that has a display, circuitry and battery in a single unit. Examples of tablets include but are not limited to: iPads®, etc. Examples of e-reader that would also fall under the definition of ‘tablet’ as used in this specification include but are not limited to: Kindles®, etc.

Further embodiments of the support may be configured for different devices, providing lacunae or slots accommodating of device features, such as buttons or ports, and for example deviating so as to provide the user or the device extra space.

The invention has been described by way of examples only and it will be appreciated that variation may be made to the above-mentioned embodiments without departing from the scope of invention as defined by the claims.

1-30. (canceled)

31. A support for a device including a display, the support comprises: a body having a first face defining a substantially flat base for resting on a surface, a second face having an elongate slot formed in the body for receiving the device so that when the first face is located on a surface and the device is supported in the slot, the device extends from the body; the slot is a suitable for maintaining an edge of the device, the support is flexible so as to enable the body to be flexed by a user to open the slot to a wider state to receive the device and then released to a relaxed state so that the slot engages with the device; and a plurality of indents are formed on the body of the support which are shaped to receive a user's fingers.

32. A support according to claim 31 wherein the body is substantially oval in plan view.

33. A support according to claim 31 wherein ends of the indents are spaced apart one from another around a periphery of the base of the body.

34. A support according to claim 31 wherein the second face of the body is rounded.

35. A support according to claim 31 wherein at least an inner surface of the slot includes a non-slip material.

36. A support according to claim 31 wherein a slot profile is adapted to correspond to a profile of the device.

37. A support according to claim 31 wherein the body comprises a semi-rigid polymer over-moulded with a soft material.

38. A support according to claim 31 wherein at least part of the body is hollow.

39. A support according to claim 31 wherein the grip mechanism includes a spring means that applies pressure to at least one side of the slot.

40. A support according to claim 39 wherein the spring means is a leaf spring embedded within the body.

41. A support according to claim 31 wherein the grip mechanism comprises a resiliently deformable member.

42. A support according to claim 31 wherein the body includes a weight.

43. A support according to claim 31 wherein the slot is shaped to avoid or provide accommodation for features on the device.

44. A support according to claim 31 includes a charging port.

45. A support according to claim 44 includes a transformer for providing a charging current.

46. A support according to claim 31 including at least one electrical port to enable electrical connection to another device.

47. A support according to claim 31 is adapted to receive at least one battery.

48. A support according to claim 31 including at least one docking station for receiving a device.

49. A support according to claim 48 wherein the docking station is adapted to be connected to a power source.

50. A support according to claim 31 including a memory means.
